(19) United States
(12) Patent Application Publication
(10) Pub. No.: US 2026/0044217 A1
(43) Pub. Date: Feb. 12, 2026

(54) GESTURE RECOGNITION APPARATUS

(71) Applicant: Augmented Sense Technologies Inc., Wilmington, DE (US)

(72) Inventors: Bryce Randle, Aurora, CO (US); Tanya Porter, Colorado Springs, CO (US); Anant Singh, Vancouver (CA)

(73) Assignee: Augmented Sense Technologies Inc., Wilmington, DE (US)

(21) Appl. No.: 19/298,043

(22) Filed: Aug. 12, 2025

Related U.S. Application Data
(60) Provisional application No. 63/682,331, filed on Aug. 12, 2024.

(51) Int. Cl. G06F 3/01; H04W 4/80

(52) U.S. Cl. CPC G06F 3/017; H04W 4/80

(57) ABSTRACT

The present disclosure provides an apparatus configured to perform gesture recognition and communicate with a smartphone, comprising one or more sensors configured to detect movement of at least one wearable component associated with a user, one or more memories configured to store gesture data, and one or more processors, coupled to the one or more memories and the one or more sensors, configured to capture, via the one or more sensors, motion data corresponding to movement of the at least one wearable component, input the motion data into a machine learning model trained to predict gestures, output, by the machine learning model, a gesture identifier based on the motion data, and transmit, via a wireless communication interface, the gesture identifier to a smartphone device.

### CROSS-REFERENCE TO RELATED APPLICATIONS

This Application claims the benefit of and priority to U.S. Provisional Patent Application No. 63/682,331, filed on Aug. 12, 2024, the entire contents of which are hereby incorporated by reference.

### FIELD OF INVENTION

Aspects of the present disclosure relate to a gesture recognition system.

### BACKGROUND

The widespread adoption of smartphones has revolutionized the way people communicate, access information, and interact with digital content. These versatile devices have become an integral part of modern life, offering a wide range of functionalities such as voice calling, text messaging, internet browsing, media playback, and more. The convenience and portability of smartphones have made them indispensable tools for personal and professional use, allowing users to stay connected and productive on the go.

However, the compact form factor and touchscreen-based interfaces of smartphones can sometimes present challenges in terms of usability and accessibility. In certain situations, such as when a user is engaged in physical activities, operating machinery, or wearing gloves, directly interacting with the smartphone's screen or buttons may be impractical, inconvenient, or even dangerous. Additionally, users with mobility impairments or visual disabilities may find it difficult to navigate the small controls and gestures required by traditional smartphone interfaces.

To address these limitations, various hands-free and accessibility solutions have been developed for smartphones. Voice-based virtual assistants, such as Apple's Siri, Google's Assistant, and Amazon's Alexa, allow users to perform tasks and retrieve information using spoken commands. These assistants leverage natural language processing and speech recognition technologies to interpret user queries and provide relevant responses. However, voice-based interaction may not always be suitable or reliable in noisy environments, public spaces, or situations requiring privacy and discretion.

Another approach to hands-free smartphone control involves the use of physical accessories or wearable devices. Bluetooth headsets and smartwatches, for example, enable users to answer calls, control media playbook, or view notifications without directly handling their phones. These devices typically rely on simple button presses, touch gestures, or voice commands to trigger specific actions on the paired smartphone. While such accessories offer some level of convenience, they often have limited functionality and may require a user to physically touch an input interface.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Despite the developments described above, there remains a need for a comprehensive and user-friendly solution that allows individuals to control their smartphones through intuitive and customizable gestures. Such a solution should be able to accurately recognize a wide range of gestures, adapt to individual user preferences, and provide a seamless integration with existing smartphone features and applications. By enabling hands-free and accessible smartphone interaction, this technology has the potential to enhance user experience, productivity, and safety in various contexts and for diverse user groups.

According to an aspect of the present disclosure, an apparatus configured to perform gesture recognition and communicate with a smartphone is provided. The apparatus comprises one or more sensors configured to detect movement of at least one wearable component associated with a user. The apparatus comprises one or more memories configured to store gesture data. The apparatus comprises one or more processors, coupled to the one or more memories and the one or more sensors, configured to capture, via the one or more sensors, motion data corresponding to movement of the at least one wearable component. The one or more processors are configured to input the motion data into a machine learning model trained to predict gestures. The one or more processors are configured to output, by the machine learning model, a gesture identifier based on the motion data. The one or more processors are configured to transmit, via a wireless communication interface, the gesture identifier to a smartphone device.

According to other aspects of the present disclosure, the apparatus may include one or more of the following features. The machine learning model may comprise one of: a convolutional neural network (CNN), a long short-term memory (LSTM) network, or a transformer-based model. The one or more sensors may comprise at least one of: an accelerometer, a gyroscope, a magnetometer, or Hall effect sensors. The one or more processors may be further configured to enter a gesture creation mode upon receiving a user command, capture motion data corresponding to a new user-defined gesture, associate the new user-defined gesture with a user-specified identifier, and update the machine learning model to recognize the new user-defined gesture using a few-shot learning technique. The wireless communication interface may utilize Bluetooth Low Energy (BLE) protocol. The at least one wearable component may comprise one or more of: a ring, a bracelet, a wristband, or a pendant. The at least one wearable component may comprise two or more separate wearable devices, and the one or more processors may be configured to synchronize motion data from the two or more separate wearable devices and combine the synchronized motion data for input into the machine learning model. The one or more processors may be further configured to detect a series of gestures performed in sequence and transmit a composite gesture identifier representing the series of gestures. The gesture identifier may comprise a unique code representing the gesture, a confidence level, and temporal metadata including gesture duration. The smartphone device may be configured to maintain a mapping table associating gesture identifiers with corresponding commands, interpret the gesture identifier based on a current context including at least one of: an active application, time of day, or location, and execute a context-specific command. The one or more processors may be further configured to receive a gesture identifier corresponding to an emergency gesture, automatically dial an emergency services number, and transmit a user's current location.

According to another aspect of the present disclosure, a method for gesture-based device control is provided. The method comprises capturing motion data from one or more sensors detecting movement of a wearable component. The method comprises extracting features from the motion data. The method comprises processing the extracted features through a trained machine learning model. The method comprises generating a gesture identifier corresponding to a recognized gesture. The method comprises transmitting the gesture identifier to a user device via wireless communication. The method comprises executing, at the user device, a command associated with the gesture identifier.

According to other aspects of the present disclosure, the method may include one or more of the following features. The method may further comprise performing calibration by capturing user-specific gesture samples, adapting recognition thresholds based on the calibration, and storing personalized gesture patterns in memory. Extracting features may comprise computing time-domain statistical measures, performing frequency-domain analysis, and deriving motion-specific features including peak acceleration and angular velocity. The method may further comprise determining a confidence level for the recognized gesture, comparing the confidence level to a dynamic threshold, and requesting user confirmation if the confidence level is below the threshold. The method may further comprise detecting a user activity state from the motion data, selecting a context-specific recognition profile based on the detected activity state, and adjusting gesture recognition sensitivity according to the selected profile.

According to another aspect of the present disclosure, a system for gesture recognition is provided. The system comprises a wearable component configured to be worn by a user. The system comprises an external module comprising sensors configured to detect movement of the wearable component and a processor executing a gesture recognition model. The system comprises a user device configured to receive gesture identifiers from the external module and execute corresponding commands. The system comprises a charging case configured to store and charge both the wearable component and the external module.

According to other aspects of the present disclosure, the system may include one or more of the following features. The external module may be configured to be mounted on one of: a user's wrist, bicycle handlebars, or wheelchair armrest. The charging case may comprise a wearable component charging portion utilizing wireless charging, an external module charging portion with contact pins, and an internal battery enabling charging without external power connection. The user device may be configured to execute one or more of the following commands in response to specific gesture identifiers: answer or reject phone calls, control media playback, capture photos or video, send predefined messages, launch applications, or control smart home devices.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a gesture identification system, according to aspects of the present disclosure.

FIG. 2 depicts a training system for the gesture identification system of FIG. 1, according to aspects of the present disclosure.

FIG. 3 depicts exemplary user interfaces for configuring and calibrating a gesture recognition system, according to aspects of the present disclosure.

FIG. 4 depicts an exemplary gesture identification system with a charging case, according to aspects of the present disclosure.

FIG. 5 depicts an alternative view of the gesture identification system of FIG. 4, according to aspects of the present disclosure.

FIG. 6 depicts an external module mounted on a wristband, according to aspects of the present disclosure.

FIG. 7 depicts the external module of FIG. 6 mounted on the wristband with a wearable component, according to aspects of the present disclosure.

FIG. 8 depicts an exemplary data structure for mapping gesture identifiers to commands, according to aspects of the present disclosure.

FIG. 9 depicts a block diagram of a computing system, according to aspects of the present disclosure.

FIG. 10 depicts a system diagram of a gesture identification system with network connectivity, according to aspects of the present disclosure.

FIG. 11 depicts a system overview of a gesture recognition and smartphone control system, according to aspects of the present disclosure.

FIG. 12 depicts a flowchart of a method for gesture-based device control, according to aspects of the present disclosure.

FIG. 13 depicts a flowchart of a method for gesture recognition and communication with a smartphone, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Aspects of the present disclosure provide apparatuses, methods, processing systems, and computer-readable mediums for gesture recognition and smartphone control using a wearable device.

Aspects of the present disclosure describe a gesture recognition system that enables users to control their smartphones and other devices through natural hand movements, even when direct physical interaction with the device is impractical or impossible. In some aspects, the system captures motion data from sensors on the wearable device, analyzes the data using machine learning models to recognize specific gestures, and translates these gestures into commands that can be executed on the smartphone. The system employs a wearable component, such as a ring or bracelet, that works in conjunction with an external sensing module to capture and interpret user gestures. By leveraging machine learning models that process real-time motion data, the system translates physical gestures into device commands, creating an intuitive hands-free interface that adapts to individual users and various environmental conditions.

Existing methods for controlling smartphones often require direct physical interaction with the device, which can be inconvenient or impractical in certain situations. For example, when a user is engaged in activities like cycling, cooking, or working with gloves on, accessing the phone's touchscreen or buttons may be difficult or disruptive. More critically, surgeons wearing sterile gloves cannot touch non-sterile phones, individuals with mobility impairments may struggle with precise touchscreen interactions, and workers in industrial or cold environments cannot operate capacitive touchscreens through heavy gloves. Additionally, voice-based assistants may not always be reliable or socially appropriate in noisy or quiet environments. Current gesture systems using cameras raise privacy concerns and fail in poor lighting conditions, while available wearable controllers typically require users to look at and touch physical buttons or touchpads on the wearable device itself, merely shifting the interaction problem rather than solving it. These limitations create a critical need for a robust, adaptable gesture recognition system that can operate reliably across diverse conditions without requiring visual attention or physical contact with any control surface.

The gesture recognition system addresses these challenges by providing a wearable device equipped with motion sensors that can detect and interpret user gestures. The system employs machine learning techniques to accurately recognize a wide range of gestures, from simple swipes and taps to more complex patterns. More specifically, aspects of the disclosed system provide a comprehensive technical solution through a multi-component architecture that captures, processes, and interprets gesture data in real-time. The system utilizes sensors, such as Hall effect sensors or accelerometers, within an external module to monitor the position and movement of a wearable component. These sensors may generate high-frequency motion data streams that are processed through a machine learning pipeline comprising feature extraction, neural network classification, and probability estimation stages. In some aspects, the system implements adaptive algorithms that dynamically adjust recognition thresholds based on environmental context and user activity states, such as distinguishing between intentional gestures and background motion during physical exercise. These recognized gestures may then be mapped to specific commands or actions on the smartphone, such as answering calls, controlling media playback, or launching applications. The system may allow for customization, enabling users to define their own gestures and associated actions through on-device learning capabilities and calibration processes.

By enabling gesture-based control, aspects of the present disclosure provide several technical benefits and measurable advantages. Some aspects provide a convenient and hands-free way to interact with smartphones, allowing users to perform tasks without directly handling their devices, with sub-100 millisecond response times while consuming minimal power through intelligent sleep-wake cycling. This may be particularly useful in situations where the user's hands are occupied or when the phone is not easily reachable. Some aspects of the present disclosure provide a more discreet and socially acceptable mode of interaction compared to voice commands, as gestures can be performed silently and unobtrusively. The machine learning models, optimized through techniques like quantization and pruning, enable real-time gesture classification on resource-constrained wearable processors while maintaining recognition accuracy above 95% even during high-motion activities. In some aspects, the use of machine learning enables the system to adapt to individual user preferences and improve gesture recognition accuracy over time, with adaptive threshold adjustment reducing false positive rates by up to 80% during physical activities. The customization options allow users to tailor the system to their specific needs and workflows, expanding the interaction vocabulary from typical 5-10 preset gestures to virtually unlimited custom commands through few-shot learning that may use 3-5 training samples per new gesture. Additionally, the system's biometric analysis within gesture sequences may provide an authentication factor with false acceptance rates below 0.1%, while the modular architecture may allow optimal positioning for different use cases, such as wrist for general use, handlebars for cycling, or wheelchair armrests for accessibility, while maintaining consistent recognition performance.

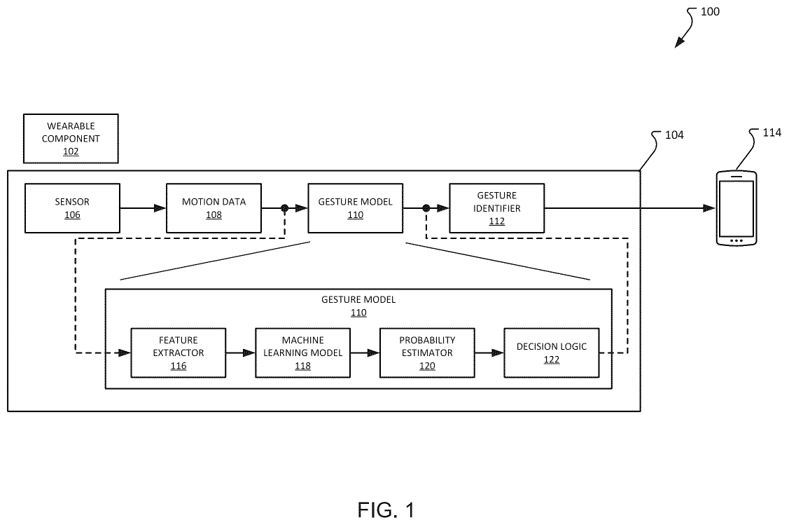

FIG. 1 depicts a gesture identification system 100 for recognizing and interpreting gestures made by a user in accordance with examples of the present disclosure. The system 100 may enable hands-free control of a user device 114, such as a smartphone or other portable electronic device, through the detection and interpretation of gestures performed by the user.

The gesture identification system 100 may include a wearable component 102, which may be worn by the user, for example, as a ring on a finger. In some aspects, the wearable component 102 can be configured in various form factors, such as a bracelet, pendant, or integrated into clothing. The wearable component 102 may be designed to detect movements made by the user, which can correspond to intentional gestures for device control and/or the wearable component 102 may be a portion of a system designed to detect and/or track movements made by a user.

An external module 104 is provided as part of the gesture identification system 100. In certain aspects, the external module 104 may be physically separate from the wearable component 102 and may be mounted, for example, on a user's wrist, bicycle handlebars, or wheelchair armrest. The external module 104 may house various components of the system, including a sensor 106, a gesture model 110, and a gesture identifier 112.

The sensor 106, which may be included in the external module 104, may be configured to detect movement of the wearable component 102. In aspects, the sensor 106 captures, obtains, and/or generates raw motion data 108 corresponding to the movements of the wearable component 102 as worn by the user. In some aspects, the sensor 106 may comprise an array of Hall effect sensors positioned in the external module 104. The Hall effect sensors may be configured to detect changes in the magnetic field produced by a small magnet embedded in the wearable component 102. In certain aspects, the sensor 106 may utilize electromagnetic field (EMF) sensing technology. In this configuration, the wearable component 102 may contain a small coil that generates a weak electromagnetic field. The sensor 106 in the external module 104 then may include an array of EMF detectors capable of sensing changes in this field as the wearable component 102 moves.

In certain aspects, the sensor 106 may additionally or alternatively incorporate pressure sensors or force-sensitive resistors to detect grip strength, touch pressure, or contact force associated with gesture performance. For example, the wearable component 102 may include pressure sensors that detect when a user makes a fist, pinches their fingers together, or applies varying levels of pressure during a gesture. These pressure measurements may provide an additional dimension of gesture recognition, enabling the system to distinguish between a light tap and a firm tap, or between an open-hand swipe and a closed-fist swipe. In some aspects, the pressure data may be synchronized with the motion data 108 to create composite gesture signatures that incorporate both movement patterns and force application. The pressure sensors may be implemented using piezoelectric materials, capacitive sensing arrays, or resistive force sensors integrated into the surface or band of the wearable component 102.

Alternatively, or in addition, and in some examples, the sensor 106 may employ radio frequency (RF) based systems. For example, the sensor 106 ay include an ultra-wideband (UWB) system, where the wearable component 102 includes a small UWB transmitter, and the sensor 106 comprises multiple UWB receivers in the external module 104 to triangulate the position of the wearable component 102. In other aspects, the sensor 106 may utilize acoustic tracking technology. In this aspect, the wearable component 102 may contain a small ultrasonic transmitter, while the sensor 106 in the external module 104 may include multiple ultrasonic receivers. These receivers may then work together to measure the time-of-flight of ultrasonic pulses and determine the position of the wearable component 102.

In some aspects, the sensor 106 may be configured to operate with high sensitivity and low latency, ensuring accurate detection of the wearable component's 102 movement and position even when it's not directly visible. In some aspects, this allows the gesture identification system 100 to function reliably in various environmental conditions and usage scenarios.

In some aspects, the motion data 108 represents the raw information captured by the sensor 106, encoding the movements of the wearable component 102 over time. In some aspects, the motion data 108 may be structured as a multi-dimensional time series, with each dimension corresponding to a different aspect of motion measured by the sensor 106. For example, in some aspects, the motion data 108 may include three-dimensional acceleration data, three-dimensional angular velocity data, and three-dimensional magnetic field data, which may be synchronized and timestamped.

In certain aspects, the motion data 108 may be preprocessed before being passed to the gesture model 110. This preprocessing can include noise reduction techniques, such as low-pass filtering to remove high-frequency jitter, or calibration adjustments to account for sensor drift or manufacturing variations. The motion data 108 may also be segmented into fixed-length windows or variable-length segments based on detected start and end points of potential gestures. In some examples, the motion data 108 may be augmented with derived quantities, such as jerk (the rate of change of acceleration) or integrated metrics like displacement, to provide additional information to the gesture model 110.

In some aspects, the motion data 108 captured by the sensor 106 may server as input to the gesture model 110. In some aspects, the gesture model 110 may be implemented as a machine learning model, such as a neural network, trained to recognize patterns in the motion data 108 that correspond to specific gestures. The gesture model 110 may process the motion data 108 to identify and classify the gestures performed by the user.

In some aspects, the gesture model 110 may be responsible for interpreting the motion data 108 and recognizing specific gestures. In some aspects, the gesture model 110 may be implemented as a deep neural network, leveraging machine learning to recognize complex patterns in the motion data 108. The architecture of the gesture model 110 may be configured to capture both spatial and temporal aspects of gestures, allowing it to recognize not just static poses but also dynamic movements over time. In certain aspects, the gesture model 110 may employ a multi-stage approach to gesture recognition. For example, the first stage may involve feature extraction, where relevant characteristics may be derived from the raw motion data 108. These features could include statistical measures (e.g., mean, variance, skewness), frequency-domain features (e.g., dominant frequencies, spectral energy distribution), and motion-specific features (e.g., peak acceleration, total angular displacement).

The second stage of the gesture model 110 may involve a sequence modeling component, such as a recurrent neural network (RNN) or transformer architecture, to capture the temporal dynamics of gestures. This allows the model to distinguish between gestures that might have similar spatial characteristics but differ in their temporal execution. In some examples, the gesture model 110 may also incorporate attention mechanisms, allowing it to focus on the most relevant parts of the input sequence when making predictions.

Following the processing by the gesture model 110, a gesture identifier 112 may be generated. In certain aspects, the gesture identifier 112 may be a unique code, text string, and/or standardized name that represents the recognized gesture. The gesture identifier 112 may serve as a compact representation of the detected gesture, suitable for transmission to the user device 114 and interpretation by the user device 114. In some aspects, the gesture identifier 112 may be implemented as a unique numerical code assigned to each recognized gesture. In some aspects, this approach allows for efficient encoding and minimal bandwidth usage when transmitting the recognized gesture to the user device 114.

In certain aspects, the gesture identifier 112 may include a descriptive text string, such as “swipe_left” or “double_tap”, providing human-readable identifiers that can be easily mapped to actions on the user device 114. The gesture identifier 112 may also include additional metadata beyond just the gesture type. For example, it might encode the confidence level of the gesture recognition, the duration of the gesture, or parameters of the gesture (e.g., the speed of a swipe or the angle of a rotation).

In some examples, the gesture identifier 112 could be designed to support composite gestures or gesture sequences. For example, in some aspects, the gesture identifier 112 may be structured as a data packet containing multiple gesture codes along with their temporal relationships. This allows for the recognition and transmission of more complex command sequences, enabling richer interaction possibilities with the user device 114.

The user device 114, which may be a smartphone, portable device, or cloud or edge device, may receive the gesture identifier 112 from the external module 104. In some examples, this communication may occur via a wireless protocol such as Bluetooth Low Energy (BLE). In certain aspects, the user device 114 may interpret the received gesture identifier 112 and execute corresponding commands or actions based on the recognized gesture. In certain aspects, the user device 114 may maintain a mapping table that associates gesture identifiers with specific actions or commands. In some aspects, this mapping may be customizable, allowing users to personalize the gesture-to-action associations according to their preferences. For example, a user might configure a “swipe right” gesture to skip to the next track in a music application, while another user might assign the same gesture to navigate to the next page in an e-book reader.

In some aspects, the user device 114 may be configured to interpret gestures contextually, taking into account the current state of the device or the active application. In some examples, the same gesture might trigger different actions depending on whether the device is locked, on the home screen, or within a specific application. This context-awareness enhances the versatility and intuitiveness of the gesture control system.

Additionally, the user device 114 may provide feedback to the user upon successful recognition and execution of gesture-based commands. This feedback can take various forms, such as visual indicators on the screen, haptic vibrations, or audio cues, confirming to the user that their gesture was recognized and the corresponding action was performed.

In some aspects, the user device 114 may also play a role in the continuous improvement of the gesture recognition system. For example, the user device 114 may collect anonymized data on gesture usage patterns and recognition accuracy, which can be used to refine and update the gesture model 110 over time. The user device 114 may also facilitate the process of adding new custom gestures, providing an interface for users to record and label new gestures that can be incorporated into their personal gesture vocabulary.

As depicted in FIG. 1, the gesture model 110 may include a feature extractor 116, a machine learning model 118, a probability estimator 120, and decision logic 122. In some aspects, the feature extractor 116 may derive meaningful characteristics from the raw motion data 108. The feature extractor 116 may transform high-dimensional, noisy sensor data into a more compact and informative representation that can be effectively processed by the subsequent machine learning model 118.

In some aspects, the feature extractor 116 employs a variety of signal processing techniques to compute relevant features from the motion data 108. These techniques may include both time-domain and frequency-domain analyses. Time-domain features may include statistical measures such as mean, variance, skewness, and kurtosis of the acceleration and angular velocity signals. These features can capture the overall intensity and distribution of motion within a gesture.

Frequency-domain features extracted by the feature extractor 116 can provide insights into the periodic nature of gestures. In certain aspects, the feature extractor 116 may apply Fourier transforms or wavelet transforms to the motion data 108, computing metrics such as the dominant frequency components, spectral energy distribution, or wavelet coefficients. These features can help distinguish between gestures with different rhythmic patterns or tempos.

In some aspects, the feature extractor 116 may compute motion-specific features that are particularly relevant to gesture recognition. Such features may include but are not limited to, the total path length of a gesture, the maximum angular velocity achieved, the smoothness of the motion trajectory, pressure or force profiles when pressure sensors are incorporated, grip strength variations throughout the gesture, and/or other biomechanical measurements. Features that capture the spatial aspects of gestures, such as the bounding box dimensions or the principal components of the motion path, can also be used for distinguishing between different types of gestures.

In certain aspects, the feature extractor 116 may employ dimensionality reduction techniques to further refine the feature set. Methods such as Principal Component Analysis (PCA) or t-SNE (t-Distributed Stochastic Neighbor Embedding) can be used to identify the most informative combinations of raw features, reducing redundancy and improving the efficiency of subsequent processing stages.

The feature extractor 116 may also be designed to handle the temporal aspects of gestures. In some aspects, the feature extractor 116 may compute features over sliding windows of the motion data 108, capturing how the characteristics of the motion evolve over time. This can be particularly useful for recognizing gestures that are defined by specific sequences of movements rather than static poses.

In some implementations, the feature extractor 116 may be implemented as a trainable component of the overall gesture model 110. For example, techniques such as convolutional neural networks or autoencoders may be used to learn optimal feature representations directly from the raw motion data 108, potentially discovering more subtle or complex features that might not be captured by hand-crafted feature extraction methods.

The extracted features may then be input into a machine learning model 118. In certain aspects, the machine learning model 118 may be implemented as a convolutional neural network (CNN), long short-term memory (LSTM) network, or a transformer-based model. The machine learning model 118 may be trained to recognize patterns in the extracted features that correspond to specific gestures. For example, and in some aspects, the machine learning model 118 may be implemented as a deep neural network, specifically designed to capture the complex spatial and temporal characteristics of gestures. The architecture of this neural network can be tailored to the nature of gesture recognition tasks. For example, a combination of convolutional layers and recurrent layers may be employed to process both the spatial and temporal aspects of gesture data effectively.

The convolutional layers within the machine learning model 118 can be particularly effective at identifying local patterns in the input features. In certain aspects, these layers may use multiple filters to detect various motion primitives, such as quick changes in acceleration or specific rotational patterns. The ability to identify these low-level motion components may enable the model to recognize a wide range of gestures, from simple taps to complex multi-part movements.

Following the convolutional layers, recurrent layers such as Long Short-Term Memory (LSTM) units or Gated Recurrent Units (GRUs) may be incorporated into the machine learning model 118. In some examples, these recurrent components may allow the model to capture long-term dependencies in the gesture sequences, recognizing patterns that unfold over time. This temporal modeling capability may be valuable in distinguishing between gestures that may have similar spatial characteristics but differ in their temporal execution.

In some aspects, attention mechanisms may be integrated into the machine learning model 118. These attention components allow the model to focus on the most relevant parts of the input sequence when making predictions. For gesture recognition, this can be particularly useful in identifying the key moments or movements that define a specific gesture, even in the presence of noise or irrelevant motions.

The output layer of the machine learning model 118 may produce a probability distribution over a set of predefined gestures. In certain aspects, this may be implemented as a softmax layer, where each output node corresponds to a specific gesture class. The activation of these output nodes represents the model's confidence in the presence of each gesture in the input data.

Training the machine learning model 118 may involve exposing it to a large dataset of labeled gesture examples. In some aspects, this training process may use techniques such as backpropagation and stochastic gradient descent to iteratively adjust the model's parameters, minimizing the difference between its predictions and the true gesture labels. Data augmentation techniques, such as adding noise or applying small transformations to the training examples, may be employed to improve the model's robustness and generalization capabilities. In certain aspects, the machine learning model 118 may be designed with transfer learning capabilities. This allows the machine learning model 118 to leverage knowledge gained from recognizing a set of common gestures when learning to recognize new, user-defined gestures. Such an approach can reduce the amount of training data required for personalizing the gesture recognition system to individual users.

The machine learning model 118 may also incorporate techniques to handle uncertainty and ambiguity in gesture recognition. In some examples, this could involve outputting not just the most likely gesture, but also confidence scores or probability distributions over multiple possible gestures. This additional information may be valuable for downstream decision-making processes, allowing the system to take appropriate actions in cases where gesture recognition is uncertain.

In certain aspects, the decision logic 122 may implement context-aware gesture recognition that dynamically adjusts sensitivity and recognition parameters based on detected user activity states. The system may utilize data from the one or more sensors 106, which may include accelerometers and gyroscopes, to determine whether the user is stationary, walking, running, cycling, or engaged in other physical activities. In some aspects, when high-motion activities are detected, such as running or exercise, the decision logic 122 may automatically adjust gesture recognition thresholds to account for increased baseline motion noise. For example, during running, the system may increase the minimum acceleration magnitude required to trigger gesture detection, preventing false positives from repetitive arm movements while maintaining the ability to recognize intentional gestures that exceed the elevated threshold.

In some aspects, multiple recognition profiles may be maintained and optimized for different activity contexts. In some examples, a “stationary profile” may enable detection of subtle, low-amplitude gestures when the user is sitting or standing still, while an “active profile” may require more pronounced, deliberate gestures during physical activities. The transition between profiles may be managed by a context classification module that continuously monitors sensor data patterns. In certain aspects, the system may implement hysteresis in profile switching to prevent rapid toggling between modes. Additionally, the feature extractor 116 may apply context-specific preprocessing filters, such as adaptive high-pass filtering during high-motion activities to remove periodic motion artifacts associated with walking or running gaits. The machine learning model 118 may be trained with context-labeled data, enabling it to learn activity-specific gesture variations and maintain consistent recognition accuracy across different user states. In some aspects, users may manually override the automatic context detection through a specific gesture or via the user interface on the user device 114, allowing them to force a particular sensitivity mode when needed.

To ensure efficient operation on the target hardware, the machine learning model 118 may undergo one or more optimization processes. In some aspects, this could involve techniques such as quantization, where model parameters are represented with reduced numerical precision, or pruning, where less important connections in the neural network are removed. These optimizations may reduce the computational requirements and memory footprint of the model, enabling real-time gesture recognition even on devices with limited resources.

Following the machine learning model 118, a probability estimator 120 may generate a probability distribution over a set of predefined gestures. In some examples, this probability distribution represents the likelihood of each possible gesture given the input motion data 108. The probability estimator 120 may quantify the confidence of the gesture recognition system in its predictions. In some aspects, the probability estimator 120 may employ a softmax function to normalize the raw output scores from the machine learning model 118 into a proper probability distribution.

In certain aspects, the probability estimator 120 may incorporate calibration techniques to ensure that the output probabilities accurately reflect the true likelihood of each gesture. This may involve methods such as Platt scaling or isotonic regression, which adjust the raw model outputs to produce well-calibrated probabilities. In certain aspects, the probability estimator 120 may also account for prior probabilities of different gestures based on historical usage patterns or contextual information. In some examples, this could involve applying Bayesian inference to combine the model's predictions with prior knowledge about gesture frequencies or likelihoods in different situations.

In addition to estimating probabilities for individual gestures, the probability estimator 120 may also compute confidence intervals or uncertainty estimates. These additional metrics can provide valuable information about the reliability of the gesture recognition in different scenarios.

Finally, in certain aspects, the decision logic 122 may interpret the output of the probability estimator 120 to determine the most likely gesture performed by the user. In some aspects, the decision logic 122 may apply thresholds to the probability distribution, handle multi-gesture sequences, or manage gesture state transitions. The output of the decision logic 122 informs the generation of the gesture identifier 112, which may be transmitted to the user device 114 for interpretation and action execution.

In certain aspects, the decision logic 122 may implement more sophisticated decision-making strategies. For example, the decision logic 122 may use a dynamic thresholding approach, where the recognition threshold adapts based on factors such as the current context, the user's recent gesture history, or the overall confidence of the probability distribution. In certain aspects, the decision logic 122 may also be designed to handle sequences of gestures or compound gestures. In some examples, this could involve maintaining a state machine that tracks partially completed gesture sequences and updates its state as new probability distributions are received from the probability estimator 120.

To enhance the reliability of gesture recognition, the decision logic 122 may incorporate temporal smoothing or filtering techniques. This can help mitigate the impact of momentary fluctuations or noise in the probability estimates, leading to more stable and consistent gesture recognition. In some aspects, the decision logic 122 may also consider the potential costs or consequences of different recognition errors. For instance, it might be more conservative in recognizing gestures that trigger irreversible actions, while being more lenient for less critical gestures. The decision logic 122 can also be responsible for handling ambiguous situations where multiple gestures have similar probabilities. In such cases, it might implement strategies such as requesting user confirmation, delaying the decision to gather more information, or choosing the most contextually appropriate gesture based on additional factors.

Finally, the decision logic 122 may generate metadata about recognized gestures, such as confidence scores, timing information, or contextual tags. This additional information can be included in the gesture identifier 112 transmitted to the user device 114, providing richer input for downstream processing and user interaction.

In certain aspects, the gesture identification system 100 may implement gesture-based authentication mechanisms to provide secure access control. The system may utilize predefined sequences of gestures as biometric authentication tokens, similar to a gestural password or PIN. In some aspects, the authentication sequence may comprise a series of three to eight distinct gestures performed in a specific order within a predetermined time window. The machine learning model 118 may be specifically trained to recognize not only the individual gestures within the authentication sequence but also the timing relationships, transition characteristics, and subtle variations in how a particular user performs their authentication gesture sequence.

The gesture authentication system may incorporate multiple security layers to prevent unauthorized access. In some examples, the system may analyze biomechanical signatures inherent in how each user performs gestures, including factors such as angular velocity profiles, acceleration patterns, gesture amplitude, and muscle tremor frequencies that are unique to an individual. These biometric markers may be extracted by the feature extractor 116 and stored as a secure user template in encrypted form within the one or more memories. During authentication attempts, the probability estimator 120 may compare the captured gesture sequence against the stored template, requiring both the correct gesture sequence and a sufficiently high biometric similarity score. In certain aspects, the system may implement anti-spoofing measures, such as detecting replay attacks by incorporating challenge-response elements where the user is to perform their authentication sequence with slight variations requested by the system, such as performing the sequence at different speeds or with modified gesture amplitudes.

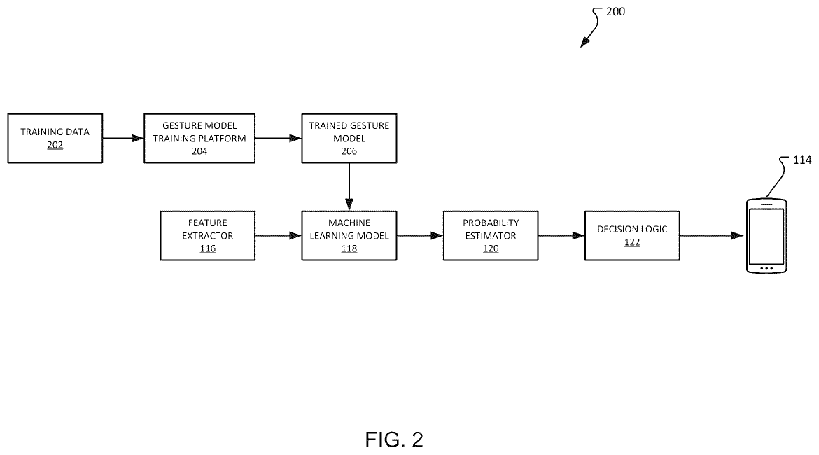

FIG. 2 illustrates a training system 200 for a gesture identification system in accordance with examples of the present disclosure. The training system 200 may be configured to generate and refine a trained gesture model 206 for use in recognizing and interpreting gestures performed by a user. The components of the training system 200 may work in concert to process training data 202, develop a robust gesture model, and prepare it for deployment in a gesture recognition application.

In certain aspects, the training system 200 may comprise several interconnected components, including a gesture model training platform 204, which receives training data 202 as input and produces a trained gesture model 206. The trained gesture model 206 may then be utilized by subsequent components in the gesture recognition pipeline, including a feature extractor 116, a machine learning model 118, a probability estimator 120, and decision logic 122. The final output of this pipeline is transmitted to a user device 114, enabling gesture-based control and interaction.

The training data 202 may be used for training an accurate and reliable gesture recognition system. In some aspects, the training data 202 may include a collection of labeled gesture samples, representing a diverse range of users, hand sizes, and movement styles. These samples may be collected through various means, such as motion capture systems, wearable sensors, or smartphone accelerometers. In certain aspects, the training data 202 may also include additional contextual information, such as the user's demographic data, environmental conditions, or device orientation, to enhance the model's ability to generalize across different scenarios.

In some examples, the training data 202 may be augmented through techniques such as data synthesis and noise injection. This augmentation process can help improve the model's robustness by exposing it to a wider variety of potential inputs. Additionally, the training data 202 may be continually expanded and refined based on real-world usage patterns and feedback, allowing the gesture recognition system to adapt and improve over time.

The gesture model training platform 204 may process the training data 202 and develop the trained gesture model 206. In some aspects, this platform may employ a variety of machine learning techniques, such as deep learning, ensemble methods, or transfer learning, to extract meaningful patterns from the training data. The gesture model training platform 204 may utilize high-performance computing resources, including GPUs or cloud-based infrastructure, to efficiently process large volumes of training data and explore different model architectures.

In certain aspects, the gesture model training platform 204 may implement an iterative training process, continuously refining the model based on performance metrics and validation results. This process may involve techniques such as cross-validation, hyperparameter tuning, and early stopping to optimize the model's performance and prevent overfitting. The platform may also incorporate techniques for handling imbalanced datasets, ensuring that the resulting model can accurately recognize both common and rare gestures.

In some aspects, the trained gesture model 206 represents the output of the gesture model training platform 204 and serves as a machine learning model of the gesture recognition system. In some aspects, the trained gesture model 206 may be implemented as a deep neural network, capable of processing raw sensor data and identifying complex gesture patterns. The architecture of this model may be designed to capture both spatial and temporal aspects of gestures, allowing it to recognize dynamic movements as well as static poses.

In some examples, the trained gesture model 206 may be optimized for deployment on resource-constrained devices, such as wearables or smartphones. In some aspects, this optimization may involve techniques such as model compression, quantization, or knowledge distillation to reduce the model's size and computational requirements while maintaining high accuracy. Additionally, the trained gesture model 206 may allow for updates or fine-tuning as new gesture data becomes available or as user preferences evolve.

The feature extractor 116, as previously described, may process the raw input data and extract relevant features for gesture recognition. In the context of the training system 200, the feature extractor 116 may be fine-tuned based on the characteristics of the trained gesture model 206. The machine learning model 118, also previously described, may be or otherwise may utilize the trained gesture model 206 to process the extracted features and identify specific gestures. In some aspects, the machine learning model 118 may leverage the unique strengths of the trained gesture model 206, such as its ability to capture temporal dependencies or recognize subtle variations in gesture execution.

In certain aspects, the probability estimator 120 and decision logic 122, as detailed earlier, may work in tandem to interpret the output of the machine learning model 118 and determine the most likely gesture performed by the user. In the context of the training system 200, these components may be calibrated to align with the performance characteristics of the trained gesture model 206, ensuring consistent and accurate gesture recognition across various usage scenarios.

The user device 114, which may be the final destination for the gesture recognition output, may receive gesture commands processed by the trained model and executed through the preceding components. In some aspects, the user device 114 may provide feedback to the training system 200, allowing for continuous improvement of the gesture recognition capabilities based on real-world usage patterns and user preferences.

In certain aspects, the gesture identification system may be configured to operate in multi-user environments where multiple users wearing gesture devices are in proximity to each other. The system may implement user disambiguation techniques to prevent cross-talk and ensure that gestures from one user do not inadvertently trigger actions on another user's device. In some aspects, each wearable component 102 may emit a unique identifier signal or operate on a distinct frequency channel, allowing the external module 104 to differentiate between multiple users based on signal characteristics such as frequency, phase, or encoded user IDs.

The multi-user disambiguation may be further enhanced through spatial filtering techniques. In some examples, the sensor 106 may employ directional sensing or beamforming to isolate signals from a specific wearable component 102 based on its spatial position relative to the external module 104. Additionally, the machine learning model 118 may be trained to recognize user-specific gesture patterns, incorporating biometric characteristics such as gesture velocity profiles, acceleration patterns, or movement trajectories unique to individual users. This user-specific training data may enable the system to maintain separate gesture profiles for multiple users, automatically switching between profiles based on the detected gesture characteristics. In certain aspects, the system may require an initial pairing gesture or authentication sequence when multiple users are detected, ensuring that subsequent gestures are correctly attributed to the appropriate user device 114.

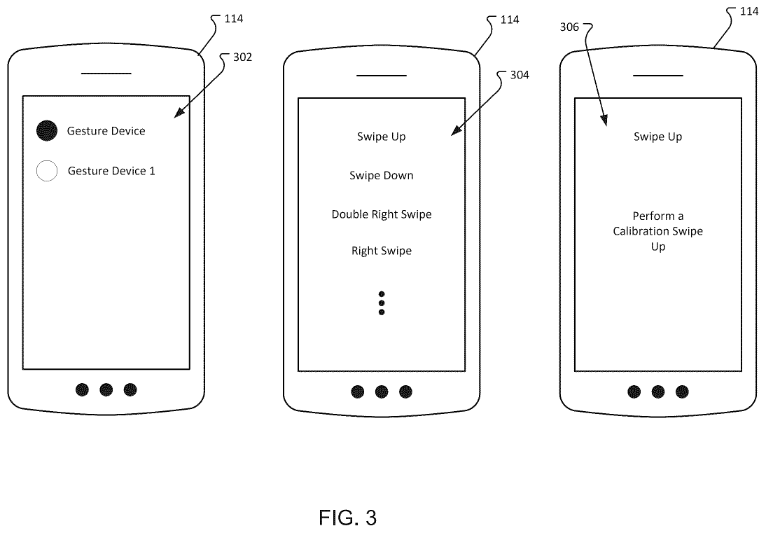

FIG. 3 illustrates exemplary user interfaces for configuring and calibrating a gesture recognition system on a user device in accordance with examples of the present disclosure. FIG. 3 depicts three sequential screens that a user might encounter when setting up and customizing the gesture-based control functionality. The user device 114, as previously described, serves as the central point of interaction for the gesture recognition system. In some aspects, the user device 114 may be a smartphone, tablet, or other portable electronic device capable of running applications and processing gesture commands. The user device 114 may be configured to communicate wirelessly with the external module 104 of the gesture recognition system, receiving gesture identifiers and executing corresponding commands based on user-defined preferences.

In certain aspects, the user device 114 may host a dedicated application for managing the gesture recognition system. This application may provide intuitive interfaces for device selection, gesture configuration, and system calibration. The user device 114 may utilize its processing capabilities to interpret received gesture identifiers and map them to specific actions or commands within various applications or system functions.

In certain aspects, the first user interface 302 displays a selection screen for choosing a gesture device. In some examples, this interface may present a list of available gesture devices that are compatible with the user device 114. The interface may show both connected and discoverable devices, allowing the user to pair new devices or select from previously connected ones. In certain aspects, the first user interface 302 may provide additional information about each listed device, such as battery status, connection strength, or device-specific features. This interface may also offer options for managing paired devices, including renaming, forgetting, or updating firmware. The selection made in this interface may determine which gesture device the subsequent configuration options will apply to, ensuring a personalized setup for each connected device.

In certain aspects, the second user interface 304 presents a list of possible gestures that can be configured for use with the selected gesture device. In some aspects, this interface may display a scrollable list of predefined gestures, each with a descriptive name and possibly an accompanying icon or animation to illustrate the gesture. The gestures shown may include simple motions like “Swipe Up” and “Swipe Down,” as well as more complex gestures such as “Double Right Swipe.” In certain examples, the second user interface 304 may allow users to customize existing gestures or create entirely new ones. This flexibility enables users to tailor the gesture recognition system to their specific needs and preferences. The interface may also provide a search or filter function to help users quickly find specific gestures within a potentially extensive list.

In some aspects, the third user interface 306 depicts a calibration screen for a selected gesture. In this example, the interface prompts the user to “Perform a Calibration Swipe Up.” This calibration process may be initiated after a user selects a gesture from the list in the second user interface 304. In some aspects, the calibration step may help the gesture recognition system adapt to the user's unique way of performing a gesture, improving recognition accuracy.

In certain examples, the calibration interface 306 may provide visual guidance on how to perform the gesture correctly. It may include a progress indicator or countdown timer to inform the user when to start and stop the calibration motion. After the calibration swipe is completed, the interface may offer feedback on the quality of the calibration and provide an option to retry if needed.

The calibration process illustrated in user interface 306 may work to personalize the gesture recognition system. In some aspects, it may allow the system to account for variations in user physiology, such as hand size or motion range, as well as differences in how individuals naturally perform certain gestures. This personalization may enhance the accuracy and reliability of gesture recognition across a diverse user base. In certain examples, the calibration data collected through interface 306 may be used to fine-tune the machine learning model employed in the gesture recognition system. This adaptive approach may enable the system to continuously improve its performance based on individual user interactions, resulting in a more responsive and accurate gesture control experience over time.

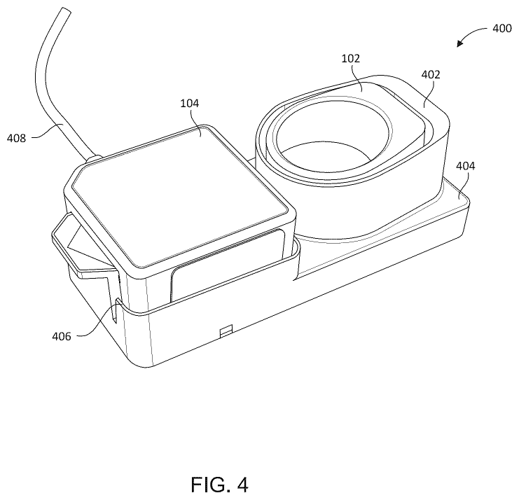

FIG. 4 depicts an exemplary gesture identification system 400 in accordance with aspects of the present disclosure. The gesture identification system 400 may be the same as or similar to the gesture identification system 100 described in previous figures. In some aspects, the gesture identification system 400 comprises various components designed to work in concert to enable gesture-based control of a user device, such as a smartphone or other portable electronic device.

The gesture identification system 400 may include a wearable component 102, which may be configured as a ring or other form factor suitable for wearing on a user's body as previously described. In some aspects, the wearable component 102 may be designed to detect and capture user movements, particularly hand and finger motions, which can be interpreted as intentional gestures for device control. The wearable component 102 may incorporate one or more sensors, such as accelerometers, gyroscopes, or magnetometers, to precisely measure and record these movements. In certain examples, the wearable component 102 may be fabricated using durable materials to withstand daily wear and various environmental conditions, ensuring consistent performance across different usage scenarios.

An external module 104 is also depicted as part of the gesture identification system 400. In some aspects, the external module 104 may house various components of the system, including sensors, processors, and communication interfaces. The external module 104 may be designed to be mounted or attached to different surfaces or objects, such as a user's wrist, bicycle handlebars, or wheelchair armrest, providing flexibility in how users interact with the system. In certain examples, the external module 104 may contain advanced processing capabilities, enabling it to perform complex computations related to gesture recognition and interpretation. The external module 104 may also facilitate wireless communication with the user device, transmitting recognized gestures for execution of corresponding commands.

The gesture identification system 400 may include a wearable component charging portion 402, which may be configured to charge the wearable component 102. In some aspects, this charging portion may utilize wireless charging technology, allowing for convenient and cable-free recharging of the wearable component. The wearable component charging portion 402 may be shaped to securely hold the wearable component 102 during the charging process, ensuring proper alignment for efficient power transfer. In certain examples, the charging portion may include indicators to display the charging status, such as LED lights that show when charging is in progress or complete. This feature may enhance the user experience by providing clear feedback on the device's power status. In some examples, the wearable component may not include active components requiring power; accordingly, the wearable component charging portion 402 may refer to an area configured to store the wearable component 102 when not in use.

A charging case 404 may be incorporated into the gesture identification system 400, serving as a protective enclosure and charging station for both the wearable component 102 and the external module 104. In some aspects, the charging case 404 may be constructed from durable materials to safeguard the components during transport or storage. The case may feature a compact and portable design, allowing users to easily carry the entire system with them. In certain examples, the charging case 404 may include its own battery, enabling it to charge the other components even when not connected to an external power source. This functionality can be particularly useful for users who are frequently on the move or in outdoor settings where access to power outlets may be limited.

The gesture identification system 400 may include an external module charging portion 406, which may be integrated into the charging case 404. In some aspects, this charging portion may be specifically designed to accommodate the external module 104, ensuring a secure fit and proper charging connection. The external module charging portion 406 may incorporate contact pins or a wireless charging coil to facilitate power transfer to the external module. In certain examples, this charging portion may be engineered to rapidly charge the external module, minimizing downtime and maximizing the system's availability for use. The design of the external module charging portion 406 may also allow for easy insertion and removal of the external module, enhancing the overall user experience.

A power cord 408 is shown connected to the charging case 404, providing a means to supply electrical power to the entire system. In some aspects, the power cord 408 may be detachable, allowing for easy replacement or use of different cord lengths as needed. The cord may be designed to be compatible with various power sources, including wall outlets, USB ports, or portable power banks, offering flexibility in how and where the system can be charged. In certain examples, the power cord 408 may incorporate features such as strain relief or reinforced connectors to enhance durability and longevity. The connection point between the power cord and the charging case may be engineered to provide a secure fit, preventing accidental disconnections during the charging process.

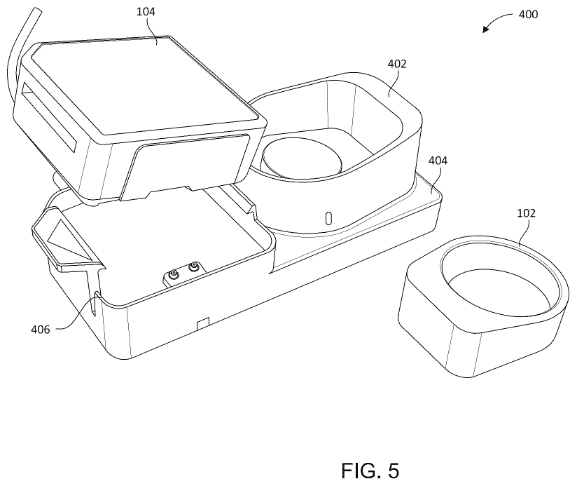

FIG. 5 illustrates an alternative view of the gesture identification system 400, which may be the same as or similar to the gesture identification system 100 described in previous figures, in accordance with examples of the present disclosure. FIG. 5 provides a perspective of the system's components in a partially disassembled state.

The gesture identification system 400 comprises a charging case 404, which serves as a central hub for storing and charging the system's components. In some aspects, the charging case 404 is designed with a compact form factor, facilitating portability and convenience for users who may need to transport the system frequently. Within the charging case 404, a wearable component charging portion 402 is visible. This section is specifically designed to accommodate and charge the wearable component 102.

The external module 104 depicted in FIG. 5 is shown as being removed from its charging position, highlighting its portability and modular nature. In some aspects, its removable design allows users to easily transport it separately from the charging case, providing flexibility in how the system is used and carried. In certain examples, the external module 104 may feature a compact and lightweight construction, making it suitable for mounting on various surfaces or wearing on the body without causing discomfort or inconvenience.

The external module charging portion 406 is clearly visible in the charging case 404, revealing the interface where the external module 104 connects for charging and storage. In some aspects, this charging portion may include contact pins or a wireless charging coil to facilitate power transfer to the external module. The design of the external module charging portion 406 may allow for easy insertion and removal of the external module, enhancing user convenience. In certain examples, this charging portion may incorporate a locking mechanism or magnetic attachment to securely hold the external module in place when stored in the charging case.

The wearable component 102, shown separately in FIG. 5, is depicted as a ring-shaped device. In some aspects, this design allows for comfortable, long-term wear on a user's finger, enabling continuous gesture detection and interaction with the system. The wearable component 102 may be constructed from materials that are both durable and skin-friendly, ensuring longevity and user comfort. In certain examples, the wearable component 102 may feature a sleek, low-profile design that doesn't interfere with the user's daily activities. In some aspects, the wearable component 102 may house sensors and components for accurate gesture detection. In some aspects, the wearable component 102 work in conjunction with one or more sensors 106 of the external module 104 for accurate gesture detection.

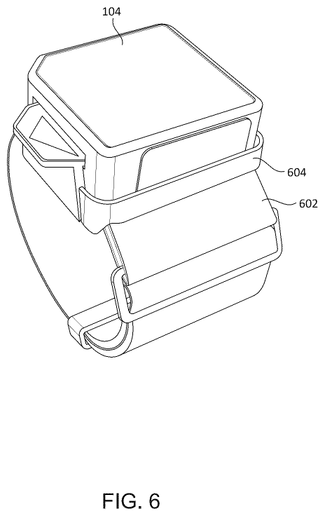

FIG. 6 depicts the external module 104 mounted on a wristband 602 in accordance with examples of the present disclosure. In some aspects, the external module 104 may include a low-profile form factor that allows for comfortable wear on the wrist. The compact nature of the external module 104 enables it to be easily integrated into wearable accessories without compromising functionality. In certain examples, the external module 104 may incorporate sensors that benefit from proximity to the user's wrist, such as heart rate monitors or skin temperature sensors, expanding its capabilities beyond gesture recognition.

The wristband 602 serves as a versatile mounting option for the external module 104. In some aspects, the wristband 602 may be fabricated from flexible, breathable materials to ensure user comfort during extended wear. The design of the wristband 602 may allow for easy adjustment to fit various wrist sizes, accommodating a wide range of users. In certain examples, the wristband 602 could be interchangeable, allowing users to switch between different styles or materials to suit their preferences or activities.

The external module 104 interface 604 is visible in FIG. 6, showcasing how the module securely attaches to the wristband 602. In some aspects, this interface may utilize a quick-release mechanism, enabling users to easily remove the external module 104 for charging or to transfer it to other mounting options. The interface 604 may be designed to provide a stable connection between the external module 104 and the wristband 602, ensuring consistent performance during various activities. In certain examples, the interface 604 could include electrical contacts to enable power transfer or data communication between the external module 104 and additional sensors integrated into the wristband 602.

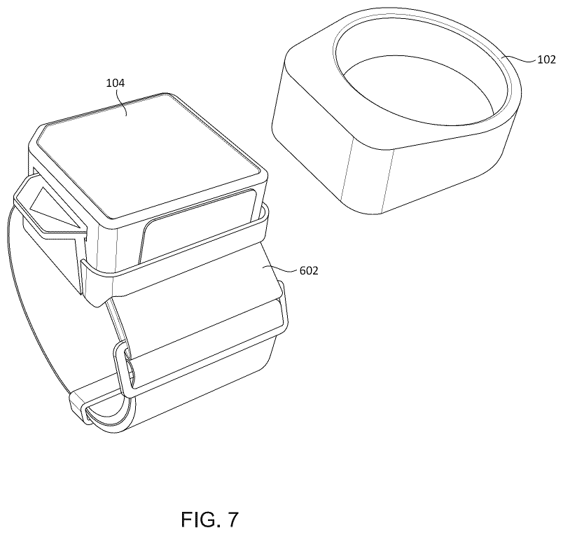

FIG. 7 illustrates the external module 104 alongside the wearable component 102, providing a comprehensive view of the main components of the gesture identification system. In some aspects, the external module 104 and wearable component 102 are designed to work in tandem, with the wearable component 102 capturing fine motor movements while the external module 104 processes and interprets these movements. The contrasting designs of these components highlight their specialized roles within the system. In certain examples, the external module 104 and wearable component 102 may utilize complementary sensors to provide a more robust and accurate gesture recognition capability. In some aspects, the external module 104, via one or more sensors 106, may detect and/or track a position of the wearable component 102.

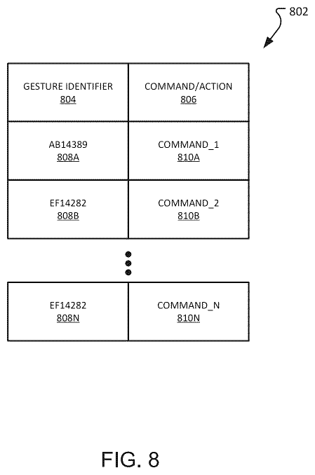

FIG. 8 illustrates an exemplary data structure 802 for mapping gesture identifiers to corresponding commands or actions in accordance with aspects of the present disclosure. The data structure 802 may be stored in the memory of the gesture identification system 400, which may be the same as or similar to the gesture identification system 100 described in previous figures. In some aspects, the data structure 802 serves as a lookup table or mapping mechanism to translate recognized gestures into actionable commands that can be executed by the user device 114.

The data structure 802 may include a gesture identifier field 804 and a command/action field 806. In certain examples, the gesture identifier field 804 stores unique codes or labels that represent specific gestures recognized by the gesture model 110. These gesture identifiers may be generated by the external module 104 based on the output of the gesture model 110 when analyzing the motion data 108 captured by the sensor 106. In some aspects, the gesture identifiers in the field 804 may be compact numeric or alphanumeric codes that efficiently encode the recognized gestures. For example, a simple code like “G01” might represent a “swipe left” gesture, while “G02” could stand for a “double tap” gesture. Using concise codes helps to minimize the size of the data structure 802 and the amount of data that needs to be transmitted between the wearable component 102 and the user device 114. In other examples, the gesture identifiers in the field 804 might be more descriptive text strings, such as “swipe_left” or “double_tap”, providing human-readable labels that can be easily understood and mapped to specific actions. These descriptive identifiers may be useful for debugging, logging, or configuring the system, as they offer a clear indication of the gestures being recognized and processed.

The command/action field 806 in the data structure 802 contains the specific commands or actions that could be triggered on the user device 114 when a corresponding gesture is recognized. In some aspects, these commands may be pre-defined by the system or application, offering a set of standard actions that can be performed based on different gestures. For example, a “swipe left” gesture might be mapped to a “previous track” command for a music player app, allowing the user to switch songs with a simple swipe motion. Similarly, a “double tap” gesture could be associated with a “play/pause” action, enabling intuitive control over media playback. In certain examples, the command/action field 806 may also support user-defined or customizable actions. The gesture identification system 400 may provide a configuration interface or API that allows users or developers to map specific gestures to desired commands or functionalities within their applications. This flexibility enables the system to adapt to different use cases and user preferences.

The data structure 802 shows example mappings between gesture identifiers 808A-808N and corresponding commands/actions 810A-810N. In this illustration, “G01” is mapped to “Action 1”, “G02” to “Action 2”, and so on. These examples demonstrate how different recognized gestures can trigger specific actions on the user device 114. In some aspects, the data structure 802 may be dynamically updated based on user configurations, application requirements, or system updates. The gesture identification system 400 may provide mechanisms to modify, add, or remove gesture-to-action mappings, ensuring that the system remains flexible and adaptable to changing needs. By utilizing the data structure 802 to map recognized gestures to corresponding commands or actions, the gesture identification system 400 enables intuitive and efficient control of the user device 114. Users can perform natural gestures captured by the wearable component 102, which are then translated into meaningful actions executed on the device, providing a seamless and hands-free interaction experience.

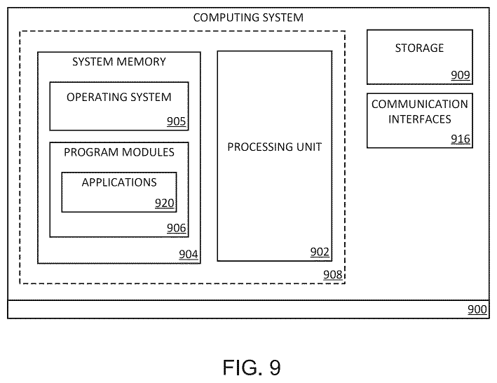

FIG. 9 illustrates a block diagram of a computing system 900 that may be used to implement aspects of the present disclosure. The computing system 900 may include various components such as a processing unit 908, a system memory 904, storage 909, a communication interface 916, and a user interface 902. In some aspects, the processing unit 908 may be responsible for executing program modules 906 and applications 920 stored in the system memory 904. The processing unit 908 may be a single or multi-core processor, a microprocessor, or any other suitable processing device capable of handling the computational tasks required by the gesture identification system.

The system memory 904 may include volatile storage (e.g., random-access memory (RAM)) and/or non-volatile storage (e.g., read-only memory (ROM), flash memory) for storing program modules 906, operating system 905, and data required for the operation of the computing system 900. In certain examples, the system memory 904 may store components of the gesture identification system, such as the gesture model 110, the data structure 802, or the configuration settings for the wearable component 102 and the user device 114.

The storage 909 may include removable and/or non-removable storage devices, such as magnetic disks, optical disks, or solid-state drives. In some aspects, the storage 909 may be used to store larger datasets, such as the motion data 108 collected by the sensor 106, the training data for the gesture model 110, or the user-defined gesture-to-action mappings. The communication interface 916 enables the computing system 900 to communicate with other devices, such as the wearable component 102, the user device 114, or remote servers. In some examples, the communication interface 916 may include radio frequency (RF) transmitter, receiver, and/or transceiver circuitry, as well as wired interfaces like universal serial bus (USB), parallel, or serial ports.

The user interface 902 may include input devices, such as a keyboard, mouse, touch or swipe input device, and output devices, such as a display or speakers. In certain aspects, the user interface 902 may be used to configure the gesture identification system, customize gesture-to-action mappings, or provide feedback to the user regarding the recognized gestures and executed commands.

Note that FIG. 9 is just one example of a processing system consistent with aspects described herein, and other processing systems having additional, alternative, or fewer components are possible consistent with this disclosure.

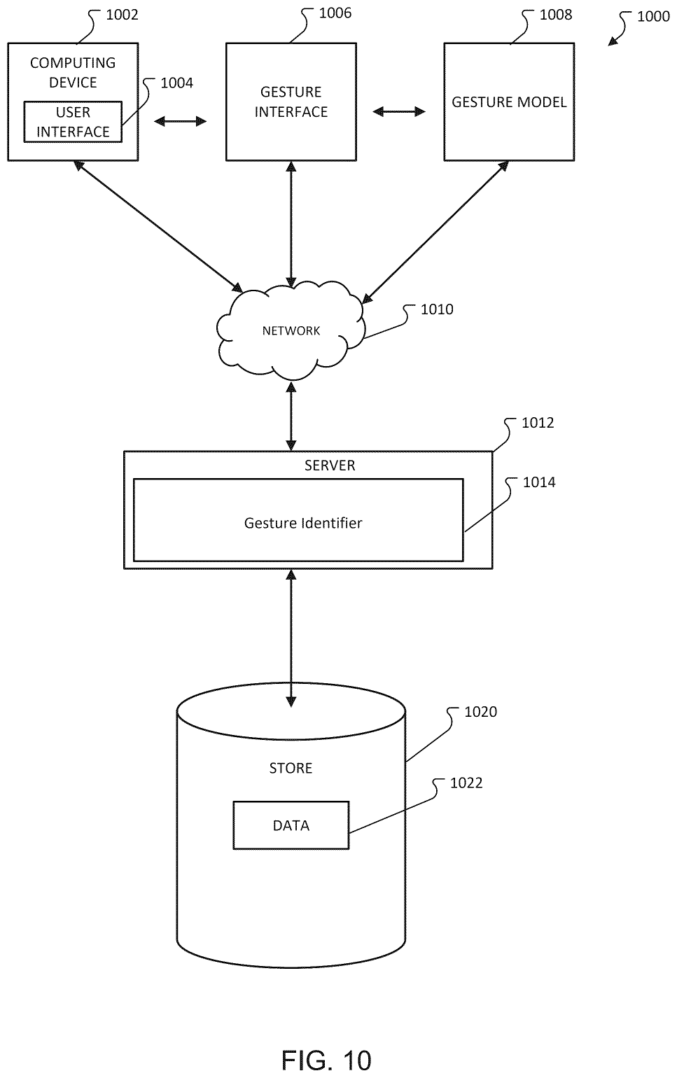

FIG. 10 illustrates a system diagram of a gesture identification system 1000 in accordance with aspects of the present disclosure. The system 1000 includes a computing device 1002, a user interface 1004, a gesture interface 1006, a gesture model 1008, a network 1010, a server 1012, and a store 1020.

In some aspects, the computing device 1002 may be a smartphone, tablet, or any other device capable of communicating with the wearable component 102 and executing commands based on recognized gestures. The computing device 1002 may host the user interface 1004, which allows users to interact with the gesture identification system, configure settings, and receive feedback.

The gesture interface 1006 may represent the wearable component 102, which includes sensors for capturing motion data and a processing unit for analyzing the data using the gesture model 1008. In certain examples, the gesture model 1008 may be a machine learning model trained to recognize specific gestures based on the motion data. The server 1012 may be a remote computing system that communicates with the computing device 1002, external module 104, and/or the wearable component 102 via the network 1010. In some aspects, the server 1012 may be responsible for storing and updating the gesture model 1008, processing the motion data, or executing complex commands that cannot be handled by the computing device 1002 alone.

The server 1012 may include a gesture identifier 1014, which may be configured to receive the output from the gesture model 1008 and generate a unique identifier for each recognized gesture. This identifier may be a standardized code, such as an alphanumeric string or a binary sequence, which uniquely represents the detected gesture and can be efficiently transmitted to the computing device 1002 for further action.

The store 1020 may be a database or any other storage system that holds the data 1022 required for the operation of the gesture identification system. This data may include user preferences, gesture-to-action mappings, motion data, or any other relevant information. In operation, the wearable component 102 captures motion data through its sensors and processes it using the gesture model 1008 to recognize specific gestures. The recognized gestures are then mapped to corresponding commands or actions, which are transmitted to the computing device 1002 via the gesture interface 1006. In some aspects, the computing device 1002 executes these commands, providing the user with a hands-free and intuitive way to control their smartphone or other connected devices.

Note that FIG. 10 is just one example of a processing system consistent with aspects described herein, and other processing systems having additional, alternative, or fewer components are possible consistent with this disclosure.

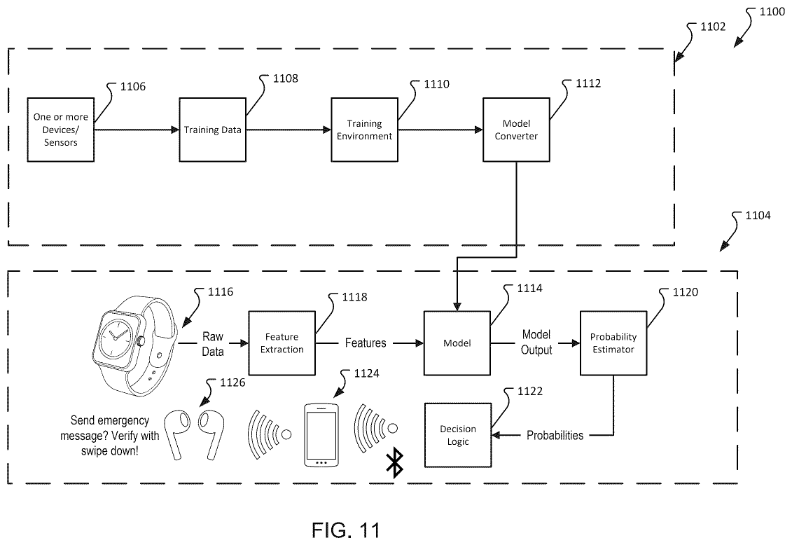

FIG. 11 illustrates a system overview of a gesture recognition and smartphone control system 1100 in accordance with aspects of the present disclosure. In certain aspects, the system 1100 includes a model generation subsystem 1102 and a real-time operation subsystem 1104, which work in concert to provide comprehensive gesture recognition capabilities.

The model generation subsystem 1102, delineated by dashed lines in the upper portion of FIG. 11, comprises several interconnected components for developing and preparing machine learning models for deployment. In some aspects, one or more devices/sensors 1106 may be utilized to collect training data 1108. These devices/sensors 1106 may include development versions of the wearable component 102 and external module 104, motion capture systems, smartphones with integrated sensors, or specialized data collection apparatus configured to capture high-fidelity gesture data from multiple users. The training data 1108 may comprise raw sensor measurements, including but not limited to accelerometer readings, gyroscope data, magnetometer measurements, and pressure sensor values, along with corresponding gesture labels and temporal annotations.

The training data 1108 is provided to a training environment 1110, which may be implemented using cloud-based platforms, high-performance computing clusters, or specialized machine learning development environments. In certain aspects, the training environment 1110 may utilize frameworks such as TensorFlow, PyTorch, or similar deep learning platforms to process the training data and generate optimized models. The training environment 1110 may employ various techniques including data augmentation, cross-validation, hyperparameter optimization, and transfer learning to develop robust gesture recognition models capable of generalizing across different users and conditions.

A model converter 1112 receives the trained model from the training environment 1110 and transforms it into a format suitable for deployment on resource-constrained devices. In some aspects, the model converter 1112 may convert models to formats such as ONNX (Open Neural Network Exchange), TensorFlow Lite, or other optimized representations. The model converter 1112 may also perform model optimization techniques including quantization, pruning, weight compression, and layer fusion to reduce the model's computational requirements and memory footprint while maintaining acceptable accuracy levels. The converted model is then deployed to the real-time operation subsystem 1104.

The real-time operation subsystem 1104, delineated by dashed lines in the lower portion of FIG. 11, represents the operational phase of the system 1100. Raw data 1116 is continuously captured from the wearable component, which may be configured as a smartwatch, fitness tracker, ring, or other wearable device as shown in the illustration. In some aspects, the raw data 1116 comprises real-time sensor measurements from accelerometers, gyroscopes, magnetometers, and potentially pressure sensors integrated into the wearable component 102 and/or external module 104.

A feature extraction module 1118 processes the raw data 1116 to derive meaningful characteristics and patterns. In certain aspects, the feature extraction module 1118 may compute time-domain features such as mean, variance, peak values, and zero-crossing rates; frequency-domain features including spectral energy, dominant frequencies, and power spectral density; and motion-specific features such as gesture velocity, acceleration profiles, and trajectory characteristics. The extracted features are structured as feature vectors optimized for efficient processing by the deployed model 1114.

The model 1114, which represents the optimized machine learning model deployed from the model generation subsystem 1102, processes the extracted features to generate model output. In some aspects, the model 1114 may be implemented as a neural network running on dedicated hardware accelerators, digital signal processors, or general-purpose processors within the external module 104 or user device 114. The model output typically comprises activation values or preliminary classification scores for each potential gesture in the system's vocabulary.

A probability estimator 1120 receives the model output and generates calibrated probability distributions over the set of possible gestures. In certain aspects, the probability estimator 1120 may apply softmax normalization, temperature scaling, or other calibration techniques to ensure the output probabilities accurately reflect the true likelihood of each gesture. The probability estimator 1120 may also incorporate prior probabilities based on user history or contextual information to improve recognition accuracy.

Decision logic 1122 processes the probabilities from the probability estimator 1120 to make final gesture determinations. In some aspects, the decision logic 1122 may implement threshold-based classification, where gestures are recognized if their probability exceeds a predetermined confidence level. The decision logic 1122 may also handle temporal aspects such as gesture sequence detection, gesture boundary determination, and rejection of ambiguous or incomplete gestures. The decision logic 1122 outputs final gesture identifiers that can be transmitted to the user device 1124.

The user device 1124, illustrated as a smartphone in FIG. 11, receives gesture identifiers via wireless communication protocols such as Bluetooth Low Energy. In some aspects, the user device 1124 maintains a mapping between gesture identifiers and executable commands, allowing recognized gestures to trigger specific actions such as answering calls, controlling media playback, or launching applications. The bidirectional wireless communication link, indicated by the wireless symbols in FIG. 11, enables the user device 1124 to send configuration updates, user preferences, and acknowledgments back to the gesture recognition system.

As illustrated in FIG. 11, the system 1100 may support various interaction modalities. A user interaction element 1126 shows example devices and scenarios, including earbuds for audio feedback, a smartphone for visual interface and command execution, and hands demonstrating gesture performance. In certain aspects, the system may provide multimodal feedback through haptic vibrations on the wearable component, audio cues through connected earbuds, and visual indicators on the smartphone display to confirm gesture recognition and command execution.

The system 1100 may also implement special gesture patterns for critical functions. As shown in the illustration, an emergency message feature may be activated by a specific gesture sequence, with the text “Send emergency message? Verify with swipe down!” indicating a two-step verification process for safety-critical commands. In some aspects, such critical gestures may bypass normal probability thresholds and trigger immediate action while still requiring deliberate confirmation to prevent false activations.

By combining the model generation subsystem 1102 and real-time operation subsystem 1104, the gesture recognition and smartphone control system 1100 enables users to interact with their devices using intuitive and natural gestures, providing a hands-free and efficient mode of interaction. The system leverages machine learning techniques to adapt to individual user patterns and improve gesture recognition accuracy over time, while also offering customization options to tailor the system to specific user preferences and needs.

In addition to gesture recognition and smartphone control, the system 1100 may also include features for proximity detection, location identification, walkaway alarm, and equipment malfunction detection. In some aspects, these features enhance the system's functionality and provide additional benefits to users.

The proximity detection feature may allow the system to sense the presence or absence of the user within a certain range of the wearable component 102, external module 104, and/or the user device 114. This can be achieved using various techniques, such as Bluetooth Low Energy (BLE) signal strength measurement or ultrasonic ranging. By monitoring the user's proximity, the system can automatically trigger specific actions or notifications, such as locking the device when the user walks away or activating power-saving modes when the user is not nearby.

The location identification feature may enable the system to determine the user's current location using positioning technologies like GPS, Wi-Fi, or cellular triangulation. This information can be used to provide location-based services, such as contextual recommendations, navigation assistance, or geofencing. For example, the system may automatically suggest relevant apps or settings based on the user's location, such as activating a fitness tracking app when the user enters a gym or enabling a silent mode when the user is in a library.

The walkaway alarm may be a security feature that alerts the user if they move too far away from their device or if the device is moved without their knowledge. When the system detects that the user has exceeded a predefined distance threshold or if unexpected motion is detected, it can trigger an audible alarm, vibration, or notification on the user's wearable component 102, external module, and/or another linked device. This feature helps prevent accidental device loss or theft and provides an additional layer of security.

The equipment malfunction detection feature may allow the system to monitor the status and performance of the wearable component 102, external module 104, and/or the user device 114. By analyzing sensor data, battery levels, and other system parameters, the system can identify potential malfunctions or anomalies, such as sensor drift, hardware failures, or battery issues. When an equipment malfunction is detected, the system can notify the user through the user interface, suggesting troubleshooting steps or prompting them to seek technical assistance. This feature helps ensure the reliable operation of the gesture recognition and smartphone control system and minimizes downtime due to equipment problems.

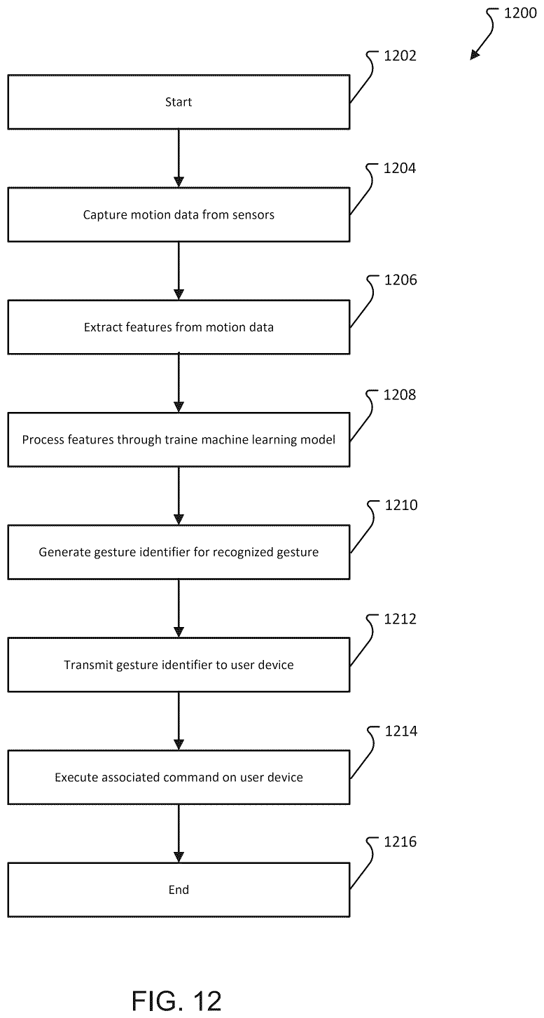

FIG. 12 illustrates a flowchart depicting a method 1200 for gesture-based device control in accordance with aspects of the present disclosure. In some aspects, the method 1200 provides an approach for capturing, processing, and interpreting gesture data to enable hands-free control of electronic devices. The method 1200 begins at step 1202 and proceeds to step 1204, where motion data is captured from one or more sensors detecting movement of a wearable component. In some aspects, this step may involve continuous monitoring of sensor outputs from accelerometers, gyroscopes, magnetometers, and/or other motion detection devices integrated into or associated with the wearable component. The captured motion data may represent the raw measurements of the user's physical movements and gestures.

The process continues to step 1206, where features are extracted from the captured motion data. In certain aspects, this feature extraction step may involve computing various statistical, temporal, and frequency-domain characteristics from the raw sensor measurements. The extracted features may include time-domain measures such as mean acceleration values, peak velocities, and/or gesture duration, and in some instances, frequency-domain features such as spectral energy distribution and/or dominant frequency components.

At step 1208, the extracted features are processed through a trained machine learning model. In some aspects, the machine learning model may be a neural network, such as a convolutional neural network, recurrent neural network, transformer-based architecture, and/or combinations thereof, that has been previously trained to recognize specific gesture patterns. The model processes the input features and generates classification scores or activation values corresponding to different possible gestures.

The method 1200 proceeds to step 1210, where a gesture identifier is generated corresponding to the recognized gesture. In certain aspects, this step may involve applying decision logic to the machine learning model's output, potentially including probability estimation and threshold-based classification. The gesture identifier may be a unique code, text string, or standardized representation that encodes the recognized gesture type along with associated metadata such as confidence levels or temporal information.

At step 1212, the gesture identifier is transmitted to a user device via wireless communication. In some aspects, this transmission may utilize protocols such as Bluetooth Low Energy, Wi-Fi, or other wireless communication standards. The gesture identifier may be formatted according to a predetermined protocol to ensure compatibility with the receiving user device.

The method 1200 continues at step 1214, where the associated command is executed on the user device. In certain aspects, the user device may maintain a mapping table that associates received gesture identifiers with specific executable commands or actions. Upon receiving the gesture identifier, the user device may interpret the identifier, determine the corresponding command, and execute the appropriate action, such as controlling media playback, answering calls, or launching applications. The execution of the command may also trigger feedback mechanisms to confirm successful gesture recognition and command execution to the user.

The method 1200 concludes with step 1216. Note that FIG. 12 is just one example of a method, and other methods including fewer, additional, or alternative operations are possible consistent with this disclosure.

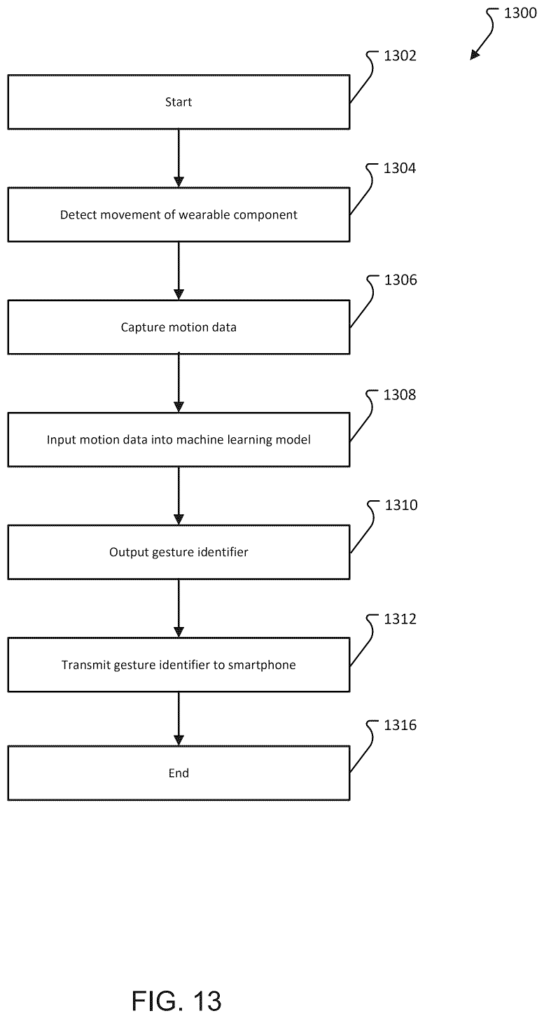

FIG. 13 illustrates a flowchart depicting a method for gesture recognition and communication with a smartphone in accordance with aspects of the present disclosure. In some aspects, the method 1300 provides a streamlined approach for detecting user gestures and transmitting corresponding identifiers to a smartphone device for command execution. The method begins at step 1302 and continues to step 1304, where movement of a wearable component is detected. In some aspects, this detection may involve monitoring the position, orientation, or motion state of the wearable component through various sensing mechanisms. The detection step may serve as a trigger to initiate the gesture recognition process when user movement is identified.

At step 1306, motion data corresponding to the detected movement is captured. In certain aspects, this step may involve collecting sensor measurements from accelerometers, gyroscopes, magnetometers, or other motion sensing devices associated with the wearable component. The captured motion data may represent the temporal characteristics of the user's gesture, including acceleration patterns, rotational movements, and positional changes.

The method proceeds to step 1308, where the captured motion data is input into a machine learning model trained to recognize gesture patterns. In some aspects, the machine learning model may be a neural network architecture optimized for processing sequential motion data and identifying specific gesture signatures. The model may analyze the input data to extract relevant features and classify the gesture based on learned patterns from training data.

Following the processing of the motion data, at step 1310, the machine learning model outputs a gesture identifier based on the processed motion data. In certain aspects, the gesture identifier may be a unique code, numerical value, or standardized representation that corresponds to the recognized gesture. The identifier may also include confidence metrics or additional metadata related to the gesture recognition process.

At step 1312, the gesture identifier is transmitted to a smartphone device. In some aspects, this transmission may utilize wireless communication protocols such as Bluetooth Low Energy, Wi-Fi, or other suitable communication standards. The smartphone may receive the gesture identifier and execute corresponding commands or actions based on predefined mappings between gesture identifiers and device functions. The method concludes at step 1314. Note that FIG. 13 is just one example of a method, and other methods including fewer, additional, or alternative operations are possible consistent with this disclosure.

Implementation examples are described in the following numbered clauses:

Clause 1: An apparatus configured to perform gesture recognition and communicate with a user device, comprising: one or more sensors configured to detect movement of at least one wearable component associated with a user; one or more memories configured to store gesture data; and one or more processors, coupled to the one or more memories and the one or more sensors, configured to: capture, via the one or more sensors, motion data corresponding to movement of the at least one wearable component; input the motion data into a machine learning model trained to predict gestures; output, by the machine learning model, a gesture identifier based on the motion data; and transmit, via a wireless communication interface, the gesture identifier to a user device.

Clause 2: The apparatus of Clause 1, wherein the machine learning model is an end-to-end neural network configured to: extract features from the motion data; generate a probability distribution over a set of predefined gestures; and output the gesture identifier based on the probability distribution.

Clause 3: The apparatus of Clause 1 or Clause 2, wherein the gesture identifier comprises one of: a unique numerical code, a text string, or a standardized gesture name.

Clause 4: The apparatus of any one of Clauses 1-3, wherein the one or more processors are further configured to: receive, from the user device, an updated mapping between gestures and gesture identifiers.

Clause 5: The apparatus of any one of Clauses 1-4, wherein the wireless communication interface utilizes Bluetooth Low Energy (BLE) protocol for transmitting the gesture identifier to the user device.

Clause 6: The apparatus of any one of Clauses 1-5, wherein the one or more processors are further configured to: update, based on the output gesture identifier, a gesture history stored in the one or more memories.

Clause 7: The apparatus of Clause 6, wherein the one or more processors are further configured to: adaptively adjust, based on the gesture history, the machine learning model.

Clause 8: The apparatus of any one of Clauses 1-7, wherein the one or more processors are further configured to: detect, based on the motion data and a gesture history, a start and an end of a gesture sequence.

Clause 9: The apparatus of any one of Clauses 1-8, wherein the one or more processors are further configured to: activate a power-saving mode when no gesture sequence is detected for a predetermined time period.

Clause 10: The apparatus of any one of Clauses 1-9, wherein the one or more sensors comprise at least one of: an accelerometer, a gyroscope, a magnetometer, or Hall effect sensors.

Clause 11: The apparatus of any one of Clauses 1-10, wherein the machine learning model comprises one of: a convolutional neural network (CNN), a long short-term memory (LSTM) network, or a transformer-based model.

Clause 12: The apparatus of any one of Clauses 1-11, wherein the one or more processors are further configured to: determine a confidence level associated with the output gesture identifier; and transmit the gesture identifier if the confidence level exceeds a predetermined threshold.

Clause 13: The apparatus of any one of Clauses 1-12, further comprising: a haptic feedback mechanism configured to provide tactile feedback to the user upon successful recognition of a gesture.

Clause 14: The apparatus of any one of Clauses 1-13, wherein the one or more processors are further configured to: receive, from the user device, a confirmation of successful execution of a command corresponding to the transmitted gesture identifier.

Clause 15: The apparatus of any one of Clauses 1-14, wherein the one or more processors are further configured to: perform on-device training to adapt the machine learning model to user specific gesture patterns.

Clause 16: The apparatus of any one of Clauses 1-15, wherein the apparatus is configured to be integrated into or mounted on one of: the at least one wearable component, a user's garment, a bicycle handlebar, or a wheelchair armrest.

Clause 17: The apparatus of any one of Clauses 1-16, wherein the one or more processors are further configured to: detect a series of gestures performed in sequence; and transmit a composite gesture identifier representing the series of gestures to the user device.

Clause 18: The apparatus of any one of Clauses 1-17, wherein the one or more processors are further configured to: receive environmental data from additional sensors; and adjust a gesture recognition process based on the environmental data.

Clause 19: The apparatus of any one of Clauses 1-18, wherein the one or more processors are further configured to: encrypt the gesture identifier before transmission to the user device.

Clause 20: The apparatus of any one of Clauses 1-19, wherein the at least one wearable component comprises: a first portion; a second portion; and wherein the first and second portions are connected and adjustably coupled to fit various user sizes or body parts.

Clause 21: The apparatus of any one of Clauses 1-20, wherein the one or more processors are further configured to: enter a gesture creation mode upon receiving a user command; capture, via the one or more sensors, motion data corresponding to a new user-defined gesture; associate the new user-defined gesture with a user-specified identifier; update the machine learning model to recognize the new user-defined gesture using a few-shot learning technique; and store the updated machine learning model and the association between the new user-defined gesture and the user-specified identifier in the one or more memories.

Clause 22: The apparatus of any one of Clauses 1-21, wherein the machine learning model is trained on: a subset of system-defined gestures that are common across all users of the apparatus; and a subset of user-defined gestures that are specific to a current user of the apparatus.

Clause 23: The apparatus of any one of Clauses 1-22, wherein the at least one wearable component comprises one or more of: a ring, a bracelet, a wristband, a pendant, an adhesive patch, or a portion of a garment.

Clause 24: The apparatus of any one of Clauses 1-23, wherein the at least one wearable component is integrated into a garment worn by the user.

Clause 25: The apparatus of Clause 24, wherein the garment is one of: a glove, a sleeve, a shirt, pants, or footwear.

Clause 26: The apparatus of any one of Clauses 1-25, wherein the at least one wearable component comprises two or more separate wearable devices worn by the user.

Clause 27: The apparatus of Clause 26, wherein the two or more separate wearable devices are configured to be worn on different parts of a user's body.

Clause 28: The apparatus of Clause 26 or 27, wherein the one or more processors are further configured to: synchronize motion data from the two or more separate wearable devices; combine the synchronized motion data; and input the combined motion data into the machine learning model.

Clause 29: The apparatus of any one of Clauses 1-28, wherein the one or more sensors are distributed among multiple wearable components.

Clause 30: The apparatus of any one of Clauses 1-29, wherein the gesture identifier is configured to cause the user device to: maintain a mapping table that associates gesture identifiers with corresponding commands; update the mapping table based on user preferences or usage patterns; and transmit updates to the mapping table to the apparatus.

Clause 31: The apparatus of any one of Clauses 1-30, wherein the gesture identifier is configured to cause the user device to: interpret the gesture identifier based on a current context of the user device, wherein the context includes at least one of: an active application, a time of day, a location, or a user activity; and execute a context-specific command.

Clause 32: The apparatus of any one of Clauses 1-31, wherein the gesture identifier is configured to cause the user device to: receive a series of gesture identifiers representing a complex gesture sequence; interpret the complex gesture sequence; and execute a corresponding complex command or macro.

Clause 33: The apparatus of any one of Clauses 1-32, wherein the gesture identifier is configured to cause the user device to: provide visual, auditory, or haptic feedback to the user in response to receiving and processing the gesture identifier.

Clause 34: The apparatus of any one of Clauses 1-33, wherein the gesture identifier is configured to cause the user device to: log received gesture identifiers and corresponding executed commands; analyze the log to identify patterns or frequently used gestures; and suggest optimizations or shortcuts to the user based on the analysis.

Clause 35: The apparatus of any one of Clauses 1-34, wherein the gesture identifier is configured to cause the user device to: receive gesture identifiers from multiple apparatus worn by the user; combine or interpret the gesture identifiers from the multiple apparatus; and execute commands based on the combined interpretation of the gesture identifiers.

Clause 36: The apparatus of any one of Clauses 1-35, wherein the gesture identifier is configured to cause the user device to: transmit the received gesture identifier to a cloud-based service for processing; receive a corresponding command or action from the cloud-based service; and execute the received command or action.

Clause 37: The apparatus of any one of Clauses 1-36, wherein the gesture identifier is configured to cause the user device to execute one or more of the following commands in response to receiving specific gesture identifiers: activate a voice assistant; answer or reject an incoming phone call; control media playback, including play, pause, skip, or volume adjustment; capture a photo or start/stop video recording; toggle silent mode or do-not-disturb mode; send a predefined text message to a predetermined contact; launch a specific application; or toggle a smart home device.

Clause 38: The apparatus of any one of Clauses 1-37, wherein the gesture identifier is configured to cause the user device to: receive a first gesture identifier corresponding to a navigation-related gesture; activate a maps application in response to the first gesture identifier; receive a second gesture identifier corresponding to a zoom gesture; and adjust a zoom level of the maps application in response to the second gesture identifier.

Clause 39: The apparatus of any one of Clauses 1-38, wherein the one or more processors are further configured to: detect an emergency gesture pattern in the motion data; and transmit an emergency gesture identifier configured to cause the user device to: automatically dial an emergency services number; activate speakerphone mode; and transmit a user's current location to the emergency services.

Clause 40: The apparatus of any one of Clauses 1-39, wherein the gesture identifier is configured to cause the user device to: receive a sequence of gesture identifiers corresponding to a custom gesture sequence; interpret the custom gesture sequence as a command to post a predefined status update; automatically compose the status update; and post the status update to one or more predetermined social media platforms.

Clause 41: The apparatus of any one of Clauses 1-40, wherein the gesture identifier is configured to cause the user device to: receive a gesture identifier corresponding to a fitness-related gesture; activate a fitness tracking application; start recording fitness metrics including at least one of: step count, heart rate, or calories burned; and provide audio feedback of current fitness metrics through connected audio output devices.

Clause 42: The apparatus of Clause 10, wherein the one or more sensors further comprise pressure sensors configured to detect at least one of: grip strength, touch pressure, finger pinch force, or contact force between the wearable component and the user's skin.

Clause 43: A method for gesture-based device control, comprising: capturing motion data from one or more sensors detecting movement of a wearable component; extracting features from the motion data; processing the extracted features through a trained machine learning model; generating a gesture identifier corresponding to a recognized gesture; and transmitting the gesture identifier to a user device via wireless communication, wherein the gesture identifier is configured to trigger execution of an associated command at the user device.

Clause 44: The method of Clause 43, further comprising: performing calibration by capturing user-specific gesture samples; adapting recognition thresholds based on the calibration; and storing personalized gesture patterns in memory.

Clause 45: The method of Clause 43 or 44, wherein extracting features comprises: computing time-domain statistical measures; performing frequency-domain analysis; and deriving motion-specific features including peak acceleration and angular velocity.

Clause 46: The method of any one of Clauses 43-45, further comprising: determining a confidence level for the recognized gesture; comparing the confidence level to a dynamic threshold; and when the confidence level is below the threshold, transmitting a confirmation request signal with the gesture identifier.

Clause 47: The method of any one of Clauses 43-46, further comprising: detecting a user activity state from the motion data; selecting a context-specific recognition profile based on the detected activity state; and adjusting gesture recognition sensitivity according to the selected profile.

Clause 48: The method of any one of Clauses 43-47, wherein the machine learning model comprises one of: a convolutional neural network (CNN), a long short-term memory (LSTM) network, or a transformer-based model.

Clause 49: The method of any one of Clauses 43-48, further comprising: detecting a series of gestures performed in sequence; generating a composite gesture identifier representing the series of gestures; and transmitting the composite gesture identifier to the user device.

Clause 50: The method of any one of Clauses 43-49, further comprising: entering a gesture creation mode upon receiving a user command; capturing motion data corresponding to a new user-defined gesture; associating the new user-defined gesture with a user-specified identifier; and updating the machine learning model to recognize the new user-defined gesture using a few-shot learning technique.

Clause 51: The method of any one of Clauses 43-50, further comprising: synchronizing motion data from two or more separate wearable devices; combining the synchronized motion data; and processing the combined motion data through the machine learning model.

Clause 52: The method of any one of Clauses 43-51, further comprising: updating a gesture history based on the generated gesture identifier; and adaptively adjusting the machine learning model based on the gesture history.

Clause 53: The method of any one of Clauses 43-52, further comprising: detecting a start and an end of a gesture sequence based on the motion data and a gesture history; and activating a power-saving mode when no gesture sequence is detected for a predetermined time period.

Clause 54: The method of any one of Clauses 43-53, further comprising: receiving environmental data from additional sensors; and adjusting the gesture recognition process based on the environmental data.

Clause 55: The method of any one of Clauses 43-54, further comprising: encrypting the gesture identifier before transmission to the user device.

Clause 56: The method of any one of Clauses 43-55, further comprising: detecting an emergency gesture pattern in the motion data; generating an emergency gesture identifier; and transmitting the emergency gesture identifier configured to cause the user device to dial an emergency services number.

Clause 57: The method of any one of Clauses 43-56, wherein transmitting the gesture identifier utilizes Bluetooth Low Energy (BLE) protocol.

Clause 58: The method of any one of Clauses 43-57, further comprising: receiving, from the user device, a confirmation of successful execution of a command corresponding to the transmitted gesture identifier; and logging the confirmation for gesture recognition improvement.

Clause 59: The method of any one of Clauses 43-58, further comprising: performing on-device training to adapt the machine learning model to user-specific gesture patterns without transmitting training data to external servers.

Clause 60: The method of any one of Clauses 43-59, wherein the gesture identifier comprises: a unique code representing the gesture; a confidence level; and temporal metadata including gesture duration.

Clause 61: The method of any one of Clauses 43-60, further comprising: analyzing biomechanical signatures inherent in gesture performance; comparing the signatures against a stored user template; and authenticating the user based on both gesture sequence accuracy and biometric similarity.

Clause 62: The method of any one of Clauses 43-61, wherein capturing motion data comprises: detecting magnetic field changes using Hall effect sensors; detecting acceleration using accelerometers; detecting angular velocity using gyroscopes; and detecting pressure using pressure sensors.

Clause 63: The method of any one of Clauses 43-62, further comprising: implementing multi-user disambiguation by detecting unique identifier signals from multiple wearable components; applying spatial filtering to isolate signals from a specific wearable component; and maintaining separate gesture profiles for multiple users.

Clause 64: The method of any one of Clauses 43-63, further comprising: detecting proximity between the wearable component and an external module; activating a walkaway alarm when separation exceeds a threshold distance; and transmitting an alert to the user device.

Clause 65: The method of any one of Clauses 43-64, wherein the gesture identifier is formatted according to a standardized API specification for third-party device integration.

Clause 66: A processing system, comprising: a memory comprising computer-executable instructions; and a processor configured to execute the computer-executable instructions and cause the processing system to perform a method in accordance with any one of Clauses 43-65.

Clause 67: A processing system, comprising means for performing a method in accordance with any one of Clauses 43-65.

Clause 68: A non-transitory computer-readable medium storing program code for causing a processing system to perform the steps of any one of Clauses 43-65.

Clause 69: A computer program product embodied on a computer-readable storage medium comprising code for performing a method in accordance with any one of Clauses 43-65.

Clause 70: A system for gesture recognition, comprising: a wearable component configured to be worn by a user; an external module comprising one or more sensors configured to detect movement of the wearable component and a processor executing a gesture recognition model; a user device configured to receive gesture identifiers from the external module and execute corresponding commands; and a charging case configured to store and charge both the wearable component and the external module.

Clause 71: The system of Clause 70, wherein the external module is configured to be mounted on one of: a user's wrist, bicycle handlebars, or wheelchair armrest.

Clause 72: The system of Clause 70 or 71, wherein the charging case comprises: a wearable component charging portion utilizing wireless charging; an external module charging portion with contact pins; and an internal battery enabling charging without external power connection.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the clement is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

A number of implementations have been described. Nevertheless, it will be understood that various modifications may be made without departing from the spirit and scope of the disclosure. Accordingly, other implementations are within the scope of the following claims.

What is claimed is:

1. An apparatus configured to perform gesture recognition and communicate with a user device, comprising:
one or more sensors configured to detect movement of at least one wearable component associated with a user;
one or more memories configured to store gesture data; and one or more processors, coupled to the one or more memories and the one or more sensors, configured to:
capture, via the one or more sensors, motion data corresponding to movement of the at least one wearable component;
input the motion data into a machine learning model trained to predict gestures;
output, by the machine learning model, a gesture identifier based on the motion data; and
transmit, via a wireless communication interface, the gesture identifier to a smartphone device.

2. The apparatus of claim 1, wherein the machine learning model comprises at least one of:
a convolutional neural network (CNN),
a long short-term memory (LSTM) network, or
a transformer-based model.

3. The apparatus of claim 1, wherein the one or more sensors comprise at least one of:
an accelerometer,
a gyroscope,
a magnetometer, or
Hall effect sensors.

4. The apparatus of claim 1, wherein the one or more processors are further configured to:
enter a gesture creation mode upon receiving a user command;
capture motion data corresponding to a new user-defined gesture;
associate the new user-defined gesture with a user-specified identifier; and
update the machine learning model to recognize the new user-defined gesture using a few-shot learning technique.

5. The apparatus of claim 1, wherein the wireless communication interface utilizes Bluetooth Low Energy (BLE) protocol.

6. The apparatus of claim 1, wherein the at least one wearable component comprises one or more of:
a ring,
a bracelet,
a wristband, or
a pendant.

7. The apparatus of claim 1, wherein the at least one wearable component comprises two or more separate wearable devices, and wherein the one or more processors are configured to:
synchronize motion data from the two or more separate wearable devices; and combine the synchronized motion data for input into the machine learning model.

8. The apparatus of claim 1, wherein the one or more processors are further configured to:
detect a series of gestures performed in sequence; and
transmit a composite gesture identifier representing the series of gestures.

9. The apparatus of claim 1, wherein the gesture identifier comprises:
a unique code representing the gesture;
a confidence level; and
temporal metadata including gesture duration.

10. The apparatus of claim 1, wherein the gesture identifier is configured to cause the smartphone device to:
maintain a mapping table associating gesture identifiers with corresponding commands;
interpret the gesture identifier based on a current context including at least one of:
an active application,
time of day, or
location; and
execute a context-specific command.

11. The apparatus of claim 1, wherein the one or more processors are further configured to:
detect an emergency gesture pattern in the motion data; and
transmit an emergency gesture identifier configured to cause the user device to dial an emergency services number.

12. A method for gesture-based device control, comprising:
capturing motion data from one or more sensors detecting movement of a wearable component;
extracting features from the motion data; processing the extracted features through a trained machine learning model;
generating a gesture identifier corresponding to a recognized gesture; and
transmitting the gesture identifier to a user device via wireless communication, wherein the gesture identifier is configured to trigger execution of an associated command at the user device.

13. The method of claim 12, further comprising:
performing calibration by capturing user-specific gesture samples;
adapting recognition thresholds based on the calibration; and
storing personalized gesture patterns in memory.

14. The method of claim 12, wherein extracting features comprises:
computing time-domain statistical measures;
performing frequency-domain analysis; and
deriving motion-specific features including peak acceleration and angular velocity.

15. The method of claim 12, further comprising:
determining a confidence level for the recognized gesture;
comparing the confidence level to a dynamic threshold; and
when the confidence level is below the threshold, transmitting a confirmation request signal with the gesture identifier.

16. The method of claim 12, further comprising:
detecting a user activity state from the motion data; selecting a context-specific recognition profile based on the detected activity state; and
adjusting gesture recognition sensitivity according to the selected profile.

17. A system for gesture recognition, comprising:
a wearable component configured to be worn by a user;
an external module comprising one or more sensors configured to detect movement of the wearable component and a processor executing a gesture recognition model;
a user device configured to receive gesture identifiers from the external module and execute corresponding commands; and
a charging case configured to store and charge both the wearable component and the external module.

18. The system of claim 17, wherein the external module is configured to be mounted on one of:
a user's wrist,
bicycle handlebars, or
wheelchair armrest.

19. The system of claim 17, wherein the charging case comprises:
a wearable component charging portion utilizing wireless charging; an
external module charging portion with contact pins; and
an internal battery enabling charging without external power connection.

20. The system of claim 17, wherein the user device is configured to execute one or more of the following commands in response to specific gesture identifiers:
answer or reject phone calls;
control media playback:
capture photos or video;
send predefined messages;
launch applications; or
control smart home devices.
